(19) United States
(12) Patent Application Publication
(10) Pub. No.: US 2026/0094838 A1
(43) Pub. Date: Apr. 2, 2026

(54) AQUEOUS ZINC-BASED BATTERY WITH A HIGH HARDNESS HETEROSTRUCTURE MATERIAL

(71) Applicant: City University of Hong Kong, Hong Kong (HK)

(72) Inventors: Jian LU, Hong Kong (HK); Yuhan CHEN, Hong Kong (HK); Jianan YIN, Hong Kong (HK)

(21) Appl. No.: 18/901,139

(22) Filed: Sep. 30, 2024

(51) Int. Cl. H01M 4/62; H01M 4/02; H01M 4/04; H01M 4/42; H01M 4/48; H01M 10/36

(52) U.S. Cl. CPC H01M 4/628; H01M 4/0471; H01M 4/42; H01M 10/365; H01M 2004/027; H01M 2004/028; H01M 4/483

(57) ABSTRACT

This invention relates to the strategy of synergizing mechanical and chemical regulations to prohibit dendrite growth on metal electrode surfaces. High-hardness materials are selected and modified to present amorphous-crystalline heterostructures. Enhanced interactions between metal ions and modified metal electrodes contribute to uniform nucleation. High hardness mechanically blocks dendrite growth. As such, the present invention further relates to an amorphous-crystalline heterostructural diamond coating modified Zn electrode and a full cell.

### FIELD OF THE INVENTION

The present invention relates to the field of materials. In particular, the present invention involves metal anode modification with high-hardness heterostructural materials.

### BACKGROUND OF THE INVENTION

Aqueous zinc-ion batteries (AZIBs) are promising for stationary energy storage systems due to their high cost-effectiveness, environmental benignity, and intrinsic safety. Zinc (Zn) foils are commonly used as anodes in AZIBs, which have the advantages of a high theoretical volumetric capacity (5855 mAh cm⁻³), low redox potential (−0.76 V vs. standard hydrogen electrode), atmospheric insensitivity, and abundant reserves. However, challenges such as the propensity for dendritic failure and thermodynamic instability in aqueous environments for Zn metal anodes still hinder the commercial use of AZIBs. For instance, the dendrite growth on Zn foils from uneven Zn deposition pierce separator and quickly causes internal short-circuit of batteries. Meanwhile, the spontaneous hydrogen evolution and parasitic corrosion on Zn anodes lead to the internal swelling and serious polarization of electrodes, drastically reducing the cycling life of AZIBs.

To address this issue, numerous modification layers (such as metal oxides, polymer materials, water-insoluble Zn-based salts, or metal-organic framework materials) for Zn anodes have been proposed to be a simple and effective method of suppressing side reactions and homogenizing Zn deposition with controlled Zn²⁺ flux and weakened interaction between Zn²⁺ and H₂O. While the delicate balance between dendrite growth and suppression is inevitably disrupted once the dendrites initiate on the Zn anodes during long-term cycling, leading to drastic dendrite proliferation and fast cell failure.

A protection layer with high hardness that can mechanically block dendrite growth has shown promise in extending the cycling life of lithium and sodium metal batteries¹⁻². Given the higher hardness (2.5 for Zn vs. 0.6 for Li and 0.4 for Na on the Mohs hardness scale) and the high growth stress of primary dendrites of Zn, it remains a challenge to develop a facile protective layer that both provides chemical protection and mechanically blocks dendrite growth for the regulation of Zn deposition and suppression of side reactions.

To achieve a balance between chemical protection and mechanical dendrite blocking, diamond has gained attention as a promising modification material for Zn anodes due to its unparalleled hardness and excellent chemical stability. However, the sp³ hybridized carbon of diamond shows limited interactions with Zn²⁺ ions.

Therefore, there remains a need in the field for the development of novel modification coating materials with high Zn affinity as well as superior hardness to overcome the high dendrite growth stress.

### SUMMARY OF THE INVENTION

It is an objective of the present invention to provide a modification layer of metal anodes to solve the aforementioned technical problems. Specifically, this modification aims to enhance electrochemical kinetics and offer abundant active sites.

The present invention paves the way for using superhard materials as candidates for metal electrode modification to mitigate dendrite issues. In a first aspect, the present invention provides an aqueous zinc-based battery with a high hardness heterostructure material. The aqueous zinc-based battery includes a reversible and dendrite-free anode, a cathode, a separator between the reversible and dendrite-free anode and the cathode and an electrolyte comprising an aqueous solution that is in ionic contact with both the reversible and dendrite-free anode and the cathode through the separator. The reversible and dendrite-free anode includes an anode material and a barrier layer with a hardness of at least 60 GPa coated on the anode material. The barrier layer is made from a local graphitization material having a nanoscale three-dimensional amorphous-crystalline heterostructure. An amorphous carbon (AC) domain is embedded in a crystalline matrix of the local graphitization material, and the barrier layer reduces a desolvation energy barrier for Zn²⁺ ions.

In one embodiment, the barrier layer exhibits hydrophobicity to prevent water-mediated side reactions at the reversible and dendrite-free anode surface.

In one embodiment, the local graphitization material includes diamond-derived materials, activated carbon, carbide, boride, nitride, or a combination thereof.

Preferably, the local graphitization material is nano dual-phase diamond (NDPD) particles fabricated via a thermal treatment.

In one embodiment, the anode material includes zinc foil, zinc powder, zinc plate, or zinc alloy.

In one embodiment, the cathode material includes MnO₂, ZnMn₂O₄, V₂O₅, or NH₄V₄O₁₀, or a combination thereof.

In one embodiment, the separator includes glass fiber, polymer membranes such as polyacrylonitrile, Nafion, polyvinyl alcohol, or cellulose-based materials such as lignocellulose, g-C₃N₄ modified cellulose, cotton cellulose).

In one embodiment, the electrolyte includes ZnSO₄, Zn(CF₃SO₃)₂, Zn(CH₃COO)₂, ZnCl₂, KOH solutions, or a combination thereof.

In one embodiment, the nanoscale three-dimensional amorphous-crystalline heterostructure is characterized by a broad peak of amorphous structure centered at approximately 2θ=26°.

In one embodiment, the reversible and dendrite-free anode is configured to exhibit reduced hydrogen evolution reaction and enhanced anti-corrosion performance compared to a bare zinc anode.

In one embodiment, the local graphitization material has an irregular flake morphology with an average size of approximately 200 nm.

In one embodiment, the aqueous zinc-based battery exhibits a cycling stability of at least 3000 hours at a current density of 5 mA/cm² with a capacity of 1 mAh/cm².

In one embodiment, the aqueous zinc-based battery maintains a nucleation overpotential of less than 90 mV during cycling.

In one embodiment, the aqueous zinc-based battery exhibits a cumulative plating capacity of at least 8000 mAh/cm² during long-term cycling.

In a second aspect, the present invention provides a method of fabricating a barrier layer with a hardness of at least 60 GPa for use in a reversible and dendrite-free anode. The method includes mixing one or more synthetic nano diamond particles with an acrylic acid ammonium salt polymer, a monomer, a cross-linking agent, a photoinitiator, and water to form a slurry; drying the slurry at a temperature of approximately 80° C. for 1-4 hours; sintering the dried slurry in an argon atmosphere at a temperature ranging from 900° C. to 2000° C. at a ramp rate of 5° C. per minute to obtain a local graphitization material; and spin-coating the local graphitization material onto an anode material to form the barrier layer.

The local graphitization material is formed with a nanoscale three-dimensional amorphous-crystalline heterostructure.

In one embodiment, the sintering process is conducted for a duration of approximately 30 hours.

In another embodiment, the method further including a cooling step following the sintering process to gradually reduce the temperature of the local graphitization material.

In one embodiment, the photoinitiator includes 2-hydroxy-2-methylpropiophenone and diphenyl(2,4,6-trimethylbenzoyl)phosphine oxide, the monomer includes acrylamide or acrylic acid, and the cross-linking agent includes N,N′-methylenebisacrylamide or hexamethylene diisocyanate.

In one embodiment, the slurry includes 50-70 wt % of one or more synthetic nano diamond particles, 1-5 wt % of acrylic acid ammonium salt polymer, 1-5 wt % of monomer, 1-5 wt % of cross-linking agent, 0.1-5 wt % of photoinitiator, and 1-10 wt % of water.

In another embodiment, the method further including ultrasonically cleaning the NDPD particles in anhydrous ethanol after the sintering process.

The present invention offers several advantages: (1) it provides a modified Zn electrode with lower nucleation overpotential and longer cycling life than a bare Zn electrode; (2) the modification procedure is simple, low-cost, and feasible for large-scale production; (3) the design of NDPD with an amorphous-crystalline heterostructure achieves high zincophilic properties and a uniform Zn²⁺ flux, attributed to the low adsorption energy of Zn atoms; and (4) this strong interaction decreases the Zn deposition energy barrier, provides more nucleation sites, and induces uniform deposition.

### BRIEF DESCRIPTION OF THE DRAWINGS

Embodiments of the invention are described in more details hereinafter with reference to the drawings, in which:

FIG. 1A shows a schematic diagram of an aqueous zinc-based battery of the present invention. FIG. 1B shows a schematic diagram of the strategy to prevent dendrite growth on the metal electrodes of batteries with the synergism of mechanical and chemical regulation;

FIG. 2 shows scanning electron microscopy (SEM) images of ND and NDPD particles;

FIG. 3A shows low magnification transmission electron microscopy (TEM) images of ND and NDPD. FIG. 3B shows a high magnification TEM image of NDPD. The insert shows the corresponding FFT pattern. FIG. 3C shows a high-resolution transmission electron microscopy (HRTEM) image of NDPD with amorphous-crystalline heterostructure;

FIG. 4 depicts X-ray diffraction (XRD) patterns of ND and NDPD;

FIG. 5A depicts Raman spectra of bare Zn, NDPD and ND. FIG. 5B depicts X-ray photoelectron spectroscopy (XPS) survey spectra of ND and NDPD. FIG. 5C depicts C Is spectra of bare Zn, NDPD and ND;

FIG. 6 depicts hardness of bare Zn, NDPD and ND;

FIG. 7 depicts N₂ adsorption-desorption isotherms of ND and NDPD;

FIGS. 8A-8B show contact angles of 2 M ZnSO₄ electrolyte on different Zn anodes;

FIG. 9A depicts LSV curves of various Zn anodes in 1 M Na₂SO₄ solution at a scan rate of 5 mV s⁻¹. FIG. 9B depicts Tafel plots of bare Zn, Zn@ND, and Zn@NDPD;

FIG. 10 shows optical images of bare Zn, Zn@ND, and Zn@NDPD before and after soaking in 2 M ZnSO₄ electrolyte for 7 days;

FIG. 11 shows SEM images of bare Zn, Zn@ND, and Zn@NDPD after immersion in 2 M ZnSO₄ electrolyte for 7 days;

FIG. 12 depicts XRD results of bare Zn, Zn@ND, and Zn@NDPD after soaking in 2 M ZnSO₄ electrolyte for 7 days;

FIG. 13 depicts EIS spectra of symmetric cells with different Zn anodes under different temperatures;

FIG. 14A depicts Arrhenius curves and activation energies of Zn²⁺ deposition on different Zn anodes in symmetric cells. FIG. 14B depicts CA plots of different Zn anodes under −200 mV. FIG. 14C depicts CV curves of symmetric cells with different Zn anodes. FIG. 14D shows ex situ SEM images of different Zn anodes before and after 100 h cycling under 1 mA cm⁻² for 1 mAh cm⁻²;

FIG. 15 depicts XRD pattern of bare Zn before cycling;

FIG. 16 depicts XRD results of bare Zn, Zn@ND, and Zn@NDPD after 100 h cycling under a current density of 1 mA cm⁻² for a capacity of 1 mAh cm⁻²;

FIG. 17 shows side views of Zn deposition behavior on Zn@ND anodes under different capacities of 1, 3, 5 mAh cm⁻² at a current density of 1 mA cm⁻²;

FIG. 18A depicts electrical conductivity measurements of NDPD using blocking electrodes with an applied current of 10 μA. FIG. 18B depicts ionic conductivity measurements of ND and NDPD;

FIG. 19 shows side views of Zn deposition behavior on Zn@NDPD anodes under different capacities of 1, 3, 5 mAh cm⁻² at a current density of 1 mA cm⁻²;

FIG. 20A depicts initial nucleation potentials of bare Zn and Zn@NDPD at 5 mA cm⁻². FIG. 20B depicts initial nucleation potentials of Zn@AC and Zn@ND at 5 mA cm⁻² for 1 mAh cm⁻². FIG. 20C depicts discharge/charge voltage profiles of bare Zn∥Cu and Zn@NDPD∥Cu asymmetric cells in the first cycle;

FIG. 21A depicts coulombic efficiency (CE) of bare Zn and Zn@NDPD plating/stripping on Cu foil at 5 mA cm⁻² for 1 mAh cm⁻². FIG. 21B depicts discharge/charge voltage profiles of bare Zn∥Cu and Zn@NDPD∥Cu asymmetric cells in different cycles 5 mA cm⁻² for 1 mAh cm⁻². FIG. 21C depicts CE of Zn@AC and Zn@NDPD plating/stripping on Cu foils at 5 mA cm⁻² for 1 mAh cm⁻². FIG. 21D depicts CE of bare Zn, Zn@AC, Zn@ND and Zn@NDPD plating/stripping on Cu foils at 10 mA cm⁻² for 1 mAh cm⁻²;

FIG. 22 depicts rate performances of bare Zn, Zn@AC, Zn@ND, Zn@NDPD symmetric cells at a fixed capacity of 1 mAh cm⁻²;

FIG. 23A depicts voltage profiles of bare Zn and Zn@NDPD symmetric cells at 5 mA cm⁻², 1 mAh cm⁻². FIG. 23B depicts a detailed profile for the failure of a bare Zn symmetric battery at 5 mA cm⁻² for 1 mAh cm⁻². FIG. 23C depicts the cycling performances of Zn@AC and Zn@ND symmetric batteries at 5 mA cm⁻² for 1 mAh cm⁻². FIG. 23D depicts voltage profiles of bare Zn and Zn@NDPD symmetric cells at 20 mA cm⁻², 1 mAh cm⁻². FIG. 23E depicts voltage profiles of bare Zn and Zn@NDPD symmetric cells at 20 mA cm⁻², 5 mAh cm⁻²;

FIG. 24 depicts a comparison of the cycling performances with the reported data;

FIG. 25 depicts a general comparison of Zn@NDPD and reported Zn anodes reported;

FIG. 26A depicts a summary of adsorption energies of Zn atoms on the different surfaces. FIG. 26B depicts adsorption of Zn atoms on different structures of bare Zn. FIG. 26C depicts adsorption of Zn atoms on the surfaces of ND (111), AC and amorphous-crystalline heterostructure interface of NDPD;

FIG. 27 depicts differences of charge density distributions at the interface of Zn atoms and different sites;

FIG. 28 depicts electron donations of Zn atoms at different sites;

FIG. 29A depicts FEM simulation results of the Zn deposition electric field for bare Zn. FIG. 29B depicts FEM simulation results of the Zn deposition electric field for Zn@NDPD. FIG. 29C depicts schematics of the Zn²⁺ flux distributions on bare Zn and Zn@NDPD in FEM simulation;

FIG. 30 shows in situ optical microscopy of bare Zn and Zn@NDPD at a current density of 10 mA cm⁻²;

FIG. 31 shows a schematic of the merits of NDPD for the improved cycling stability of Zn anodes;

FIG. 32A shows SEM and EDS of Cu—MnO₂ powder. FIG. 32B depicts the XRD pattern of Cu—MnO₂ powder;

FIG. 33A depicts CV curves of bare Zn∥Cu-MnO₂ and Zn@NDPD∥Cu-MnO₂. FIG. 33B depicts rate performance of bare Zn∥Cu-MnO₂ and Zn@NDPD∥Cu-MnO₂. FIG. 33C depicts voltage-capacity curves of full cells with bare Zn and Zn@NDPD at different current densities. FIG. 33D depicts charge/discharge profiles of bare Zn∥Cu-MnO₂ and Zn@NDPD∥Cu-MnO₂;

FIG. 34 depicts EIS curves of bare Zn∥Cu-MnO₂ and Zn@NDPD∥Cu-MnO₂;

FIG. 35 depicts long-term cycle performance of bare Zn∥Cu-MnO₂ and Zn@NDPD∥Cu-MnO₂;

FIG. 36 shows SEM images of bare Zn and Zn@NDPD anodes at 2 A g⁻¹ after 1000 cycles in full cells; and

FIG. 37 shows self-discharge behavior of Zn@NDPD∥Cu-MnO₂. Photograph of punch cells with Zn@NDPD anodes powering an LED pattern.

### DETAILED DESCRIPTION

In the following description, NDPD with amorphous-crystalline heterostructure and NDPD coated zinc anode are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The highly reversible plating/stripping of Zn is plagued by dendrite growth and side reactions on metallic Zn anodes, retarding the commercial application of aqueous Zn-ion batteries.

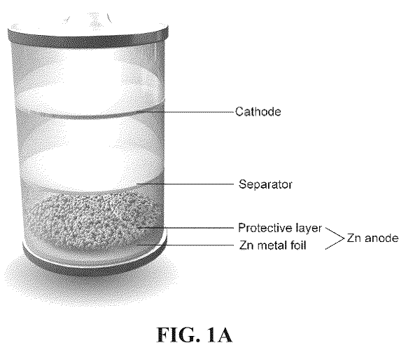

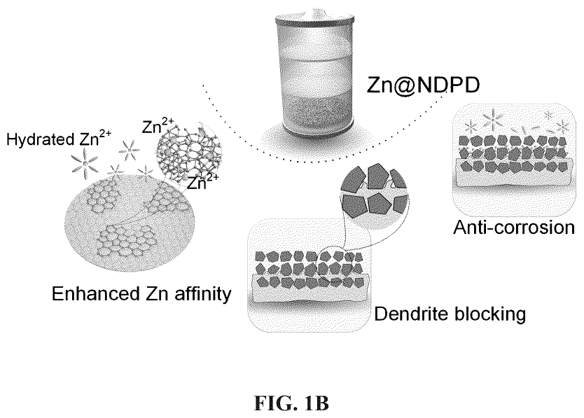

In view of this, the present invention provides a strategy of coupling high hardness and Zn affinity to prevent dendrite initiation and propagation. In particular, the present invention provides an aqueous zinc-based battery with a high hardness heterostructure material. The aqueous zinc-based battery includes a reversible and dendrite-free anode, a cathode, a separator between the reversible and dendrite-free anode and the cathode and an electrolyte comprising an aqueous solution that is in ionic contact with both the reversible and dendrite-free anode and the cathode through the separator (FIG. 1A). FIG. 1B shows a schematic diagram of the present invention to prevent dendrite growth on the metal electrodes of batteries with the synergism of mechanical and chemical regulation. Specifically, superhard materials are chosen as the modification layers of metal electrodes. The amorphous-crystalline structure of the superhard materials in selected materials facilitates the interaction with metal ions, thereby reducing the energy barrier when deposited on metal electrodes. Moreover, the superior hardness of modification materials mechanically blocks dendrite growth. Hence, a uniform and reversible stripping/deposition on the metal anode is realized. This strategy is suitable for metal electrodes suffering from dendrite issues to achieve an extended cycle life in Zn, Li, Na, K based batteries.

In one embodiment, the superhard materials are NDPD coated metal anode. The NDPD protective coatings, combining enhanced zinc affinity with exceptional hardness, facilitate dendrite-free Zn plating and stripping in the NDPD-coated Zn (referred to here as Zn@NDPD) structure. The unique amorphous-crystalline heterostructure of NDPD is designed to control Zn deposition and mechanically prevent dendrite formation. The NDPD structure, with its numerous amorphous-crystalline heterointerfaces, acts as zincophilic sites that enhance the cycling stability of the modified Zn anodes. These heterointerfaces promote homogeneous nucleation and, coupled with the high hardness of NDPD, mitigate the high growth stress of dendrites, thereby preventing their proliferation.

In addition, the heterostructure lowers the reaction energy barrier for interfacial reactions and retains the superior hardness from nanodiamond (ND), enabling the effective mechanical blocking of dendrite propagation and growth in long-term cycling.

In one embodiment, the anode material may include zinc, lithium, sodium, potassium-based materials, such as foils, powders, or composites.

In one embodiment, the hardness of the NDPD is in a range of 50-99 GPa. The modification materials with superior hardness can overcome the high growth stress of dendrite and mechanically block dendrite growth.

Preferably, the hardness of the NDPD is at least 70 GPa.

Moreover, the hydrophobic surfaces of the NDPD facilitate the desolvation of hydrated Zn²⁺ and prevent water-mediated side reactions. By preventing reactive water molecules from reaching the Zn anode surface, these hydrophobic surfaces effectively suppress unwanted side reactions.

Given the advantageous properties of NDPD, including its hardness and hydrophobic nature, it is highly suitable for use in battery technologies. Specifically, Zn@NDPD electrodes leverage these characteristics to enhance overall battery performance. Zn@NDPD electrodes are highly compatible with different aqueous electrolytes. Examples of the electrolytes may include ZnSO₄, Zn(CF₃SO₃)₂, Zn(CH₃COO)₂, ZnCl₂, and KOH electrolytes. Other than Cu—MnO₂ cathode, various cathodes commonly used in aqueous batteries, like MnO₂, ZnMn₂O₄, V₂O₅, and NH₄V₄O₁₀, are also available to assemble full batteries with Zn@NDPD.

The NDPD-coated metal anodes of the present invention offer several key performance advantages, including:

(1) Dendrite suppression: the high hardness of the NDPD coating effectively prevents the growth of zinc dendrites, a common issue that leads to short circuits and battery failure. The mechanical blocking of dendrites ensures the long-term stability of the metal anode.

(2) Enhanced Zn deposition: the amorphous-crystalline heterostructure of the NDPD particles provides numerous active sites for zinc-ion adsorption, facilitating uniform deposition and reducing the likelihood of dendrite formation.

(3) Hydrophobicity: the NDPD coating exhibits hydrophobic properties, which reduce the penetration of water molecules into the zinc anode, thereby mitigating water-mediated side reactions that can degrade the anode's performance over time.

(4) Extended cycling stability: the Zn@NDPD anodes exhibit exceptional cycling stability, maintaining a stable performance for over 3200 hours at a current density of 5 mA/cm², with a low nucleation overpotential within 90 mV. This represents a significant improvement over conventional zinc anodes.

In one embodiment, the symmetric cells with dendrite-free Zn@NDPD show an extended cycling stability of at least 3200 h while maintaining an excellent nucleation overpotential within 90 mV at a current density of 5 mA cm⁻² with a capacity of 1 mAh cm⁻².

In one embodiment, the Zn@NDPD∥Cu-MnO₂ full cell presents a stable specific capacity of approximately 110.5 mAh g⁻¹ after 1000 cycles.

In summary, the present invention provides a hydrophobic NDPD with amorphous-crystalline dual-phase heterostructure as a modification layer for Zn anodes. The abundant amorphous-crystalline heterointerfaces in NDPD endow the Zn@NDPD with lower adsorption energy for Zn²⁺ and a lower deposition barrier for realizing the thermostability of the system. Meanwhile, the deposition and growth behavior of Zn are regulated effectively for stable plating/stripping cycling.

In addition, the hydrophobicity of NDPD prohibits side reactions efficiently. This innovative chemical and mechanical synergetic regulation give Zn@NDPD symmetric cells or the Zn@NDPD∥Cu-MnO₂ full cell an ultralong lifespan exceeding 3200 h at 5 mA cm⁻² with a low nucleation overpotential within 90 mV, high CE of nearly 100% of bare Zn counterparts, and an excellent CPC of 8000 mAh cm⁻². Furthermore, full cells assembled with a Cu—MnO₂ cathode can also deliver an improved rate capacity and cycling stability.

### EXAMPLE

### Example 1

### Formation of NDPD Particles

The NDPD particles are fabricated via a facile thermal treatment of the precursor containing original diamond and binders. The original diamond is a commercially available synthetic nano diamond powder provided by Tianjian Carbon Material Co., Ltd., China. The nano diamond particles (200 nm) are fully mixed with acrylic acid ammonium salt polymer (≥99%), acrylamide (≥99%), N,N′-Methylenebisacrylamide (≥99%), 2-hydroxy-2-methylpropiophenone (≥99%), diphenyl(2,4,6-trimethylbenzoyl) phosphine oxide (≥99%) and water in a specific weight ratio of 60:3.3:2.4:4:0.24:7.3. After that, the uniformly mixed slurry is cured under UV light with a wavelength of 365 nm to obtain the precursor. Then, the precursor is dried at 80° C. in an oven (Froilabo, France) for 4 hours. Subsequently, the precursor is sintered in an Ar atmosphere at 1250° C. at a ramp rate of 5° C. min⁻¹ to obtain the NDPD particles. All samples are ultrasonically cleaned in anhydrous ethanol. The sintering process is conducted in a tube furnace (BTF-1700C, ANHUI BEQ EQUIPMENT TECHNOLOGY CO., LTD., China). The sintering time for the samples presented in the manuscript is 1800 min.

### Example 2

### Characterization of the NDPD Particles

In this embodiment, commercial nanodiamond powders are coated with an organic-coated diamond precursor and then subjected to a sintering process at a temperature range from 900 to 2000° C. with a 1-30 h holding time in an argon atmosphere. Through local graphitization, amorphous phases with nano-size are embedded into the original crystalline phases to form abundant heterostructures.

Similar heterostructures can be achieved in activated carbon (AC), carbide, boride, and nitride under corresponding precursor cladding and sintering.

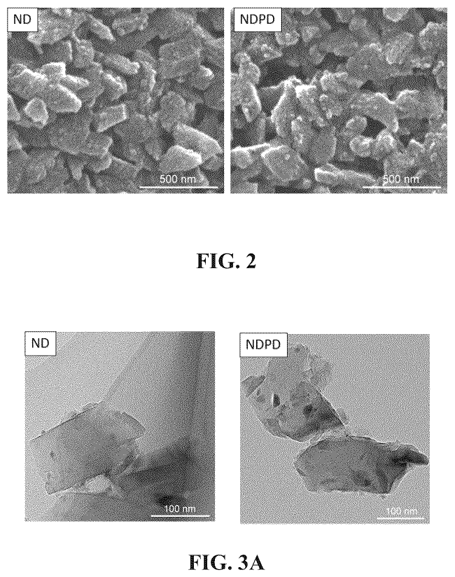

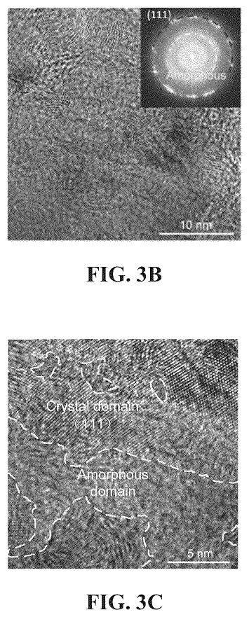

The SEM images show that the NDPD particles have an irregular flake morphology with an average size of approximately 200 nm and rough surfaces, which well maintains the original morphology of commercial ND (FIG. 2). The TEM images further show the flaky structure of NDPD and commercial ND (FIG. 3A). High-magnification TEM shows a typical amorphous-crystalline dual-phase pattern of NDPD (FIGS. 3B-3C), and the corresponding fast Fourier transform (FFT) (inset in FIG. 3B) image shows a well-defined crystal ring and a broad and diffuse ring, further confirming the amorphous-crystalline dual-phase nature of NDPD. Moreover, the HRTEM images reveal the amorphous-crystalline dual-phase structure, in which the amorphous domain is embedded in the crystalline matrix of diamond, which is completely different from the traditional core-shell type amorphous-crystalline structure of diamond with surface graphitization³. Such an amorphous-crystalline dual-phase structure is expected to provide abundant active interfacial sites for Zn²⁺ flux and Zn deposition.

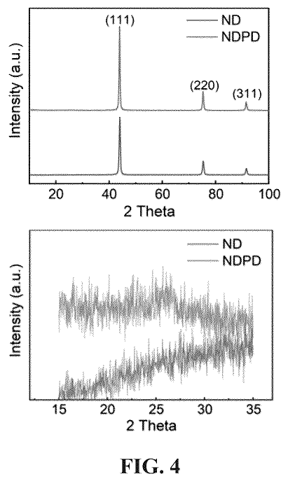

In addition, the XRD results verify the amorphous-crystalline dual-phase structure of NDPD given the characteristic (111) and (200) diffraction peaks of crystalline diamond and a broad peak of amorphous structure centered at approximately 2θ=26° (FIG. 4). With the incorporation of the amorphous structure, the (111) and (220) diffraction peaks of the crystalline phase in NDPD are found to be slightly shifted to the right by approximately 0.1 degrees, indicating nanoscale lattice distortion.

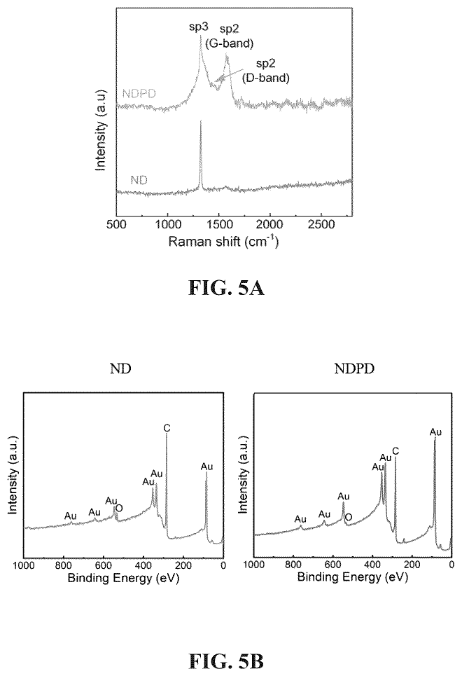

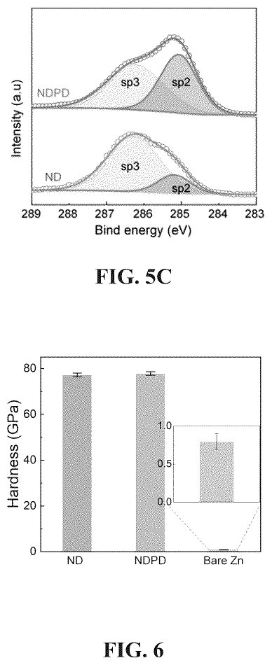

The amorphous-crystalline dual-phase structure and transformation are also supported by Raman spectra. Referring to FIG. 5A, the commercial ND only shows a sharp and single peak at 1320 cm⁻¹ corresponding to the first-order Raman spectrum line of diamond phase with sp³ hybridized bonding, whereas the NDPD displays a broad sp³ peak at 1320 cm⁻¹ and two additional broad characteristic peaks at 1445 cm⁻¹ (D band) and 1583 cm⁻¹ (G band) corresponding to sp² hybridized carbon from disordered AC. In addition, the broadness of these Raman peaks suggests the ultra-small nature of the crystal region retained from the pristine crystal ND and lattice distortion due to the formation of the amorphous-crystalline heterostructure.

The XPS survey spectrum confirms that the NDPD is composed of C and O, which is similar to that of ND (FIG. 5B), indicating that the formation of the NDPD is independent of other elements from the binder. Moreover, the C Is spectrum shows an obvious increase in the content of sp² carbon to 54 at % in the NDPD, contributing to the formation of heterostructure in the NDPD (FIG. 5C). Therefore, it can be deduced that the carbonization and annealing process contribute to the localized graphitization of ND, causing the formation of numerous nano sp² AC phases inside the diamond. With this process, the innovative NDPD with nanoscale three-dimensional (3D) amorphous-crystalline heterostructure can be obtained.

Moreover, since a material's hardness is linked to its ability to mechanically block dendrite formation in metal anodes, the hardness of NDPD is assessed. Nano-indentation tests are conducted with a loading of 100 mN. It is difficult to measure the hardness of NDPD particles owing to the nanoscale size. Therefore, large bulk samples are prepared with the same treatment to obtain the same heterostructure for the nano-indentation tests. Three points are tested for each sample, and the average hardness is calculated.

Referring to FIG. 6, the NDPD exhibits a hardness of 77.8 GPa and thus well maintains the hardness of commercial ND, indicating that the construction of amorphous-crystalline dual-phase heterostructure has little effect on the mechanical properties of diamond.

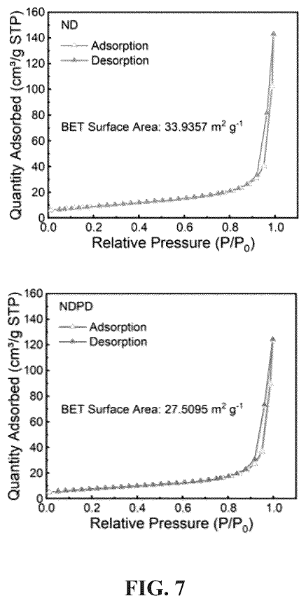

Furthermore, N₂ adsorption isotherm results (FIG. 7) reveal a high surface area retained after transformation from NDPD (27.5095 m² g⁻¹) to ND (33.9357 m² g⁻¹). The porous skeleton could provide enriched reaction sites for Zn anodes and thus is beneficial to reduce the local current density and promote uniform Zn deposition.

### Example 3

### Fabrication of Zn@NDPD Anode

The protective coatings of the Zn anode are fabricated by blending ND or NDPD powder and polyvinylidene fluoride (binder) in a mass ratio ranging from 7:3 to 9:1, using N-methyl-2-pyrrolidone solution as solvent. The obtained slurry shows a concentration range of 0.1-0.2 g/mL for ND or NDPD. The obtained slurry is then spin-coated onto the Zn foils, referred to as Zn@ND and Zn@NDPD, respectively. The spin-coating is conducted at the temperature range of 25-70° C. Drying is performed at 120° C. for 12 h in a vacuum oven. Finally, the thickness of coatings is expected to be 10-20 μm.

### Example 4

### Electrochemical Performance Evaluation of Zn

C2032 coin cells are assembled to test the electrochemical properties of Zn electrodes, where glass fiber (Whatman GF/A 1823-070) and 2 M ZnSO₄ aqueous solution (100 μL) are used as separator and electrolyte, respectively. For full cells, 2 M ZnSO₄ with a 0.3 M MnSO₄ additive is used as electrolyte to compensate for the capacity loss of Cu—MnO₂ during cycling. The specific capacities are calculated based on the mass of Cu—MnO₂.

The bare Zn∥Cu-MnO₂ and Zn@NDPD∥Cu-MnO₂ full cells are tested in the range of 0.9-1.9 V.

Galvanostatic charge/discharge of the cells is measured using battery-testing instruments (Neware BTS-610 Instrument). Cyclic voltammetry (CV) curves are recorded at different scanning rates using a CHI 660E electrochemical station. Linear sweep voltammetry is conducted in the 1 M Na₂SO₄ aqueous solution at a scanning rate of 1 mV s⁻¹.

To assess the impact of the protective coating on the Zn²⁺ plating/stripping CE, measurements are made for bare Zn∥Cu and Zn@NDPD∥Cu cells. The symmetric cells of Zn∥Zn, Zn@ND∥Zn@ND and Zn@NDPD∥Zn@NDPD are measured to estimate the cycling stability improvement from protective coating. Additionally, the thermodynamic stability of Zn@ND and Zn@NDPD anodes, Zn deposition kinetics and the effects on dendrite suppression with superior hardness are also evaluated.

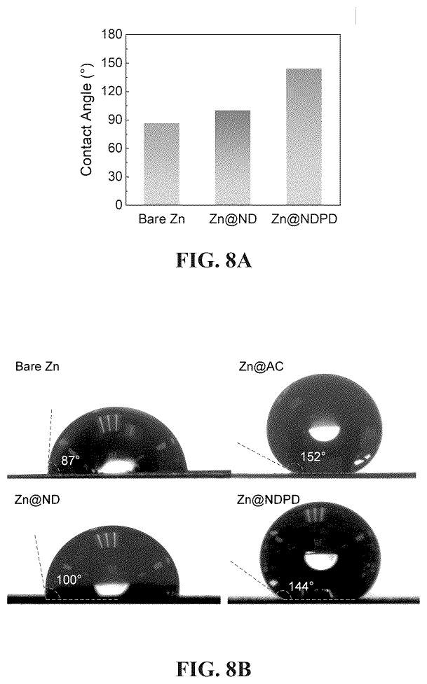

Turning to FIG. 8A, the coating of ND on Zn anodes only slightly changes the contact angle with the ZnSO₄ electrolyte. In contrast, the contact angle significantly increases to 144° with the NDPD coating, indicating that the hydrophobicity of the Zn@NDPD electrode is significantly improved, which may be attributed to the localized graphitization within the NDPD (FIG. 8B). The enhanced hydrophobicity will prevent electrolyte permeation to Zn metal anodes and massive electron migrations between water molecules and anodes thus mitigating the side reactions of Zn@NDPD anodes.

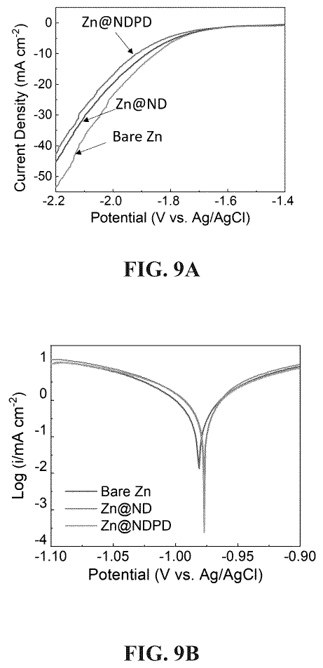

Hydrogen evolution reaction (HER) and anti-corrosion performance of Zn anodes are evaluated. The linear sweep voltammogram curves (LSV) in FIG. 9A show the occurrence of HER for Zn@NDPD at a more negative potential with a lower current density than bare Zn and Zn@ND, indicating the effective suppression of hydrogen evolution by the NDPD coating. Meanwhile, Tafel plot of Zn@NDPD shows a positive shift in the corrosion potential from −0.981 V (bare Zn) to −0.977 V (vs. Ag/AgCl) (FIG. 9B), along with a decreased corrosion current density of 0.096 mA cm⁻² relative to bare Zn (0.132 mA cm⁻²) and Zn@ND (0.110 mA cm⁻²).

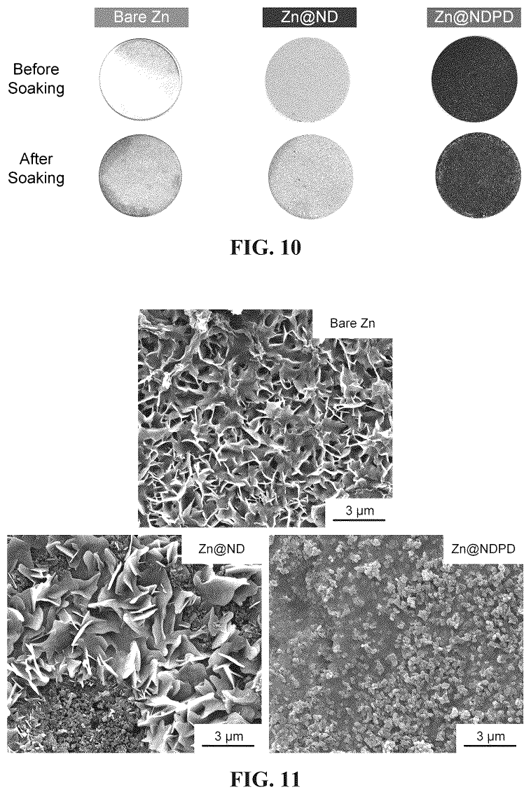

Referring to FIGS. 10-11, the Zn@NDPD, Zn@ND, and bare Zn are immersed in 2 M ZnSO₄ electrolyte for 7 days to investigate their long-term side reaction suppression. After soaking, an obvious white coverage with a morphology of numerous ultra-thin microsheets can be observed on the bare Zn and Zn@ND, whereas Zn@NDPD maintains the original morphology well, providing strong evidence of the superior side reaction suppression ability of NDPD.

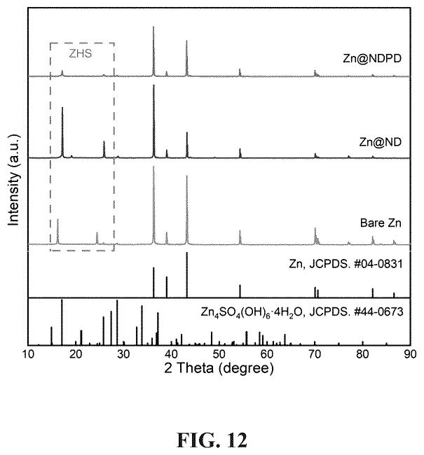

XRD analysis reveals that relative to the Zn@ND and bare Zn anodes, there is a sharp decrease in the formation of Zn₄SO₄(OH)₆·4H₂O (ZHS) corresponding to the reaction of locally enriched OH on the Zn surfaces enabled by HER with electrolyte on Zn@NDPD (FIG. 12). Therefore, the insulation of electron/ion transport and hindrance of Zn deposition kinetics by ZHS is greatly reduced, confirming the heightened anti-corrosion performance of Zn@NDPD.

### Example 5

### Impact of NDPD Modification on Desolvation, Stability, and Electrochemical Performance

Zn deposition is a complex process that involves the sequential occurrence of mass transfer, desolvation, charge transfer, and crystallization (nucleation and growth)⁴. In aqueous electrolyte, Zn²⁺ ions are tightly bound to the surrounding solvent shell under a coulombic interaction, existing as hydrated Zn²⁺ ([Zn(H₂O)₆]²⁺), which results in large desolvation penalties at the electrolyte-electrode interfaces and hinder the Zn deposition kinetics⁵.

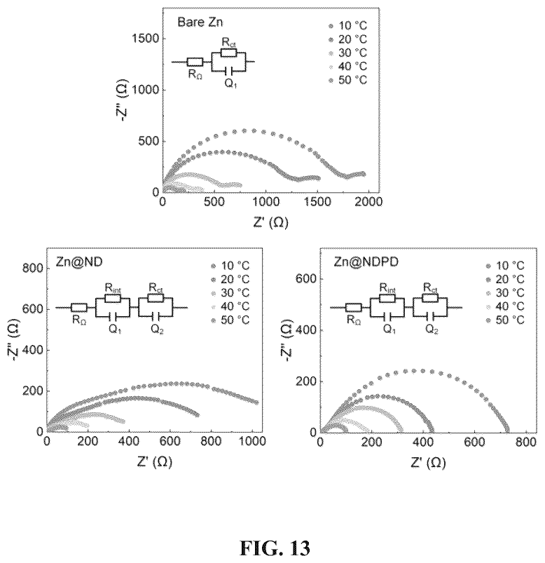

Turning to FIG. 13 and Table 1, the desolvation energy barrier of hydrated Zn²⁺ is evaluated by Arrhenius activation energy (Eₐ), which can be derived from electrochemical impedance spectra (EIS) results obtained at different temperatures. The desolvation process can be described by the activation energy (Eₐ) according to the Arrhenius equation:

$$\frac{1}{{R}_{c t}} = A exp ( - \frac{{E}_{a}}{R T} )$$

where R_{ct} is the charge transfer resistance, A is the frequency factor; R is the gas constant, and T is the absolute temperature.

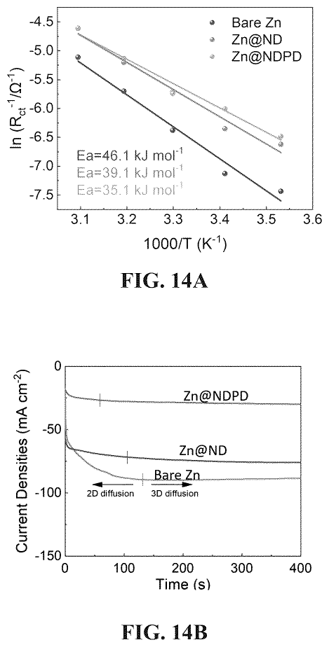

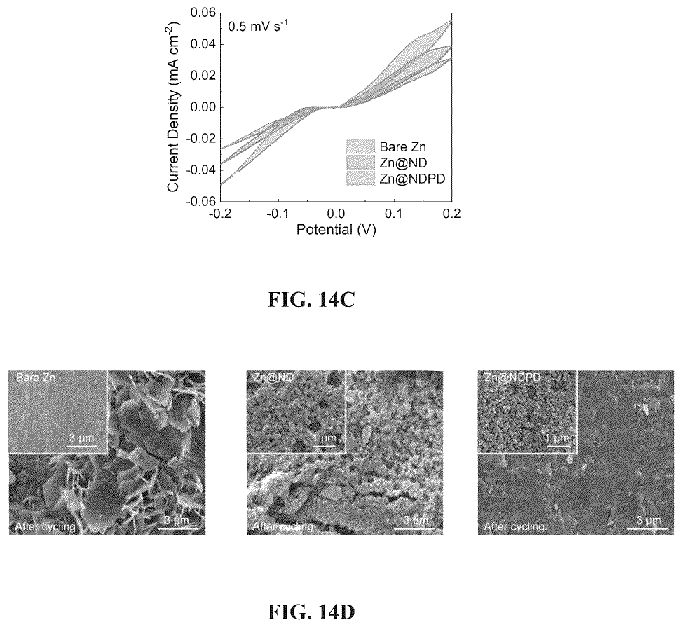

A much lower Eₐ for Zn@NDPD (35.1 kJ mol⁻¹) than that for bare Zn (46.1 kJ mol⁻¹) and Zn@ND (39.1 kJ mol⁻¹) confirms the improved desolvation with NDPD modification (FIG. 14A).

TABLE 1
The fitting resistance results of the symmetric cells

| Symmetric | Resistance | 10° C. | 20° C. | 30° C. | 40° C. | 50° C. |
|---|---|---|---|---|---|---|
| cells | (Ω) | (Ω) | (Ω) | (Ω) | (Ω) | (Ω) |
| Bare Zn | R_{ct} | 1695 | 1248 | 590.1 | 299.1 | 165.9 |
| Zn@ND | R_{ct} | 750.9 | 573.5 | 303.7 | 181.6 | 100.8 |
| Zn@NDPD | R_{ct} | 654.3 | 405 | 310.8 | 169.6 | 100.1 |

In addition, chronoamperometry (CA) curves show that the Zn@NDPD quickly completes two-dimensional (2D) diffusion process (60 s) and achieves a steady response current by 3D diffusion (FIG. 14B), whereas the bare Zn and Zn@ND undergo a rampant and longer 2D diffusion process (130 and 110 s, respectively) with much higher current densities, indicating a local reduction of Zn²⁺ with less migration and causing uniform nucleation and deposition for Zn@NDPD.

According to the enhanced thermodynamic stability and Zn deposition kinetics as discussed, the symmetric cell with Zn@NDPD exhibits broaden redox peaks and a higher response current density in CV process than the counterparts, confirming that the NDPD coating enriches the charge carrier and increases electrochemical activation (FIG. 14C).

To further elucidate the synergism of chemical protection and mechanical dendrite impedance for dendrite-free Zn deposition on Zn@NDPD surfaces, the morphological evolutions of different Zn anodes before and after cycling are investigated (FIG. 14D). After cycling for 100 h, bare Zn is covered with unfavorable thin flakes with a disordered orientation, causing accelerated dendrite growth and a rapid short-circuit. However, benefiting from the unparalleled hardness, a dendrite-free surface is obtained on Zn@ND even under random Zn nucleation owing to the limited Zn deposition thermodynamics and kinetics discussed above. The bare Zn anode shows disordered dendrite growth following 100 cycles. In contrast, Zn@NDPD presents a smooth Zn deposition attributed to the synergism of mechanical and chemical regulation (FIG. 14D). The enhanced Zn affinity and superior hardness of the NDPD enables homogenized nucleation and growth of Zn. These results verify the dendrite suppression of NDPD coating on the Zn anode.

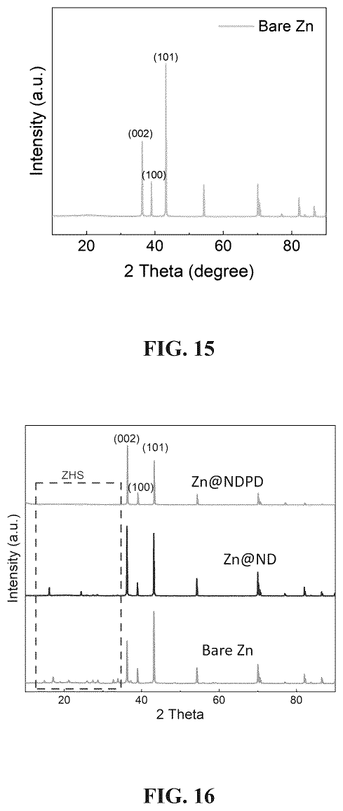

In addition, no ZHS is detectable on the Zn@NDPD anode after cycling. And the significantly increased intensity of Zn (002) peak further indicates the stabilization of Zn anodes and the regulation of Zn deposition along (002) facet by the NDPD coating (FIGS. 15-16). These results show the enhanced reversibility and anti-corrosion of Zn anodes with amorphous-crystalline dual-phase heterostructural NDPD coating during the stripping and deposition cycling process.

To evaluate the Zn deposition behavior on the Zn@ND and Zn@NDPD anodes, the plating Zn is detected with varying deposition capacities from 1 mAcm⁻² to 5 mAh cm⁻² at a current density of 1 mA cm⁻².

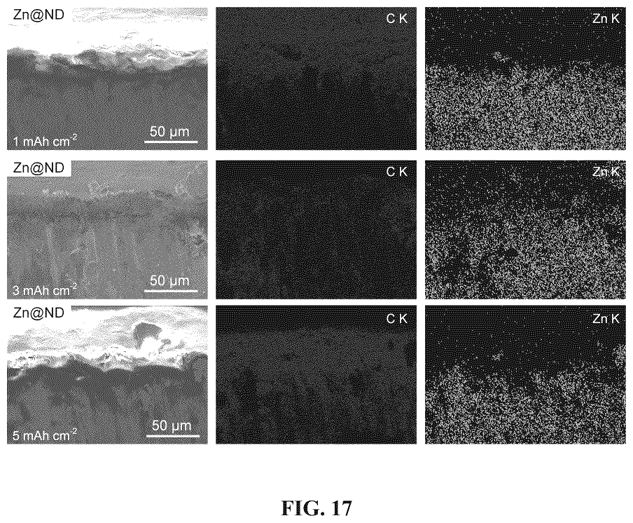

As shown in FIG. 17, which displays the Zn deposition behavior on the Zn@AC-D anodes under incremental deposited capacities. It shows the Zn deposits the Zn/AC-D interface first and then grows along the coating layer. This process ensures mechanical dendrite blocking. The deposited Zn is inclined to nucleate and grow beneath the ND coatings, which is also attributed to the intrinsic electrical insulation of ND.

The electrical conductivities of NDPD are evaluated by the direct voltage-current measurements using blocking electrodes and galvanostatic charge approach. The stainless steel blocking electrodes coated with ND and NDPD respectively are assembled into coin cells without electrolyte and galvanostatic charged at a current of 10 uA. The electrical conductivity (ρ) is calculated according to the following equation:

$$ρ = \frac{I \cdot L}{U \cdot S}$$

where I is the applied current, U is the voltage corresponding to I, S is the contact area, and L is the thickness of the coating.

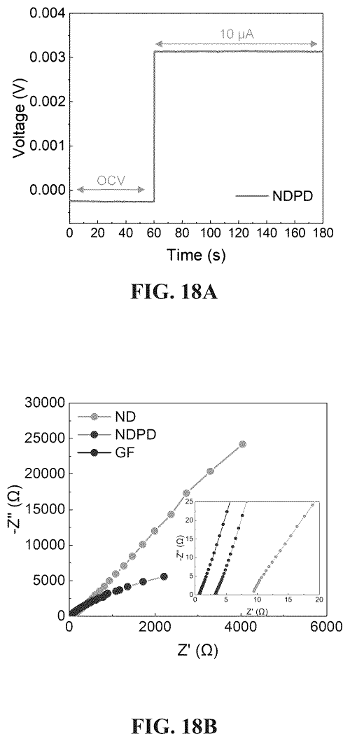

With the transformation from ND to NDPD, the localized graphitization of ND endows NDPD with an electrical conductivity of 3.18×10⁻⁷ S cm⁻¹ (FIG. 18A).

The ionic conductivities of ND and NDPD are tested with EIS measurements. In these experiments, ND and NDPD powders are coated on the stainless steel blocking electrodes first. Then the glass fiber separators wetted by ZnSO₄ electrolyte are sandwiched in bare stainless steel electrode and ND/NDPD coated SS electrode. And the resistances of modification layers can be calculated as follows,

$$R = R ( total ) - R ( glass fiber ) .$$

The ionic conductivity (ρᵢₒₙ) is calculated according to the following equation:

$${ρ}_{i o n} = \frac{I \cdot L}{U \cdot S}$$

where I is the applied current, U is the voltage corresponding to I, S is the contact area, and L is the thickness of coating.

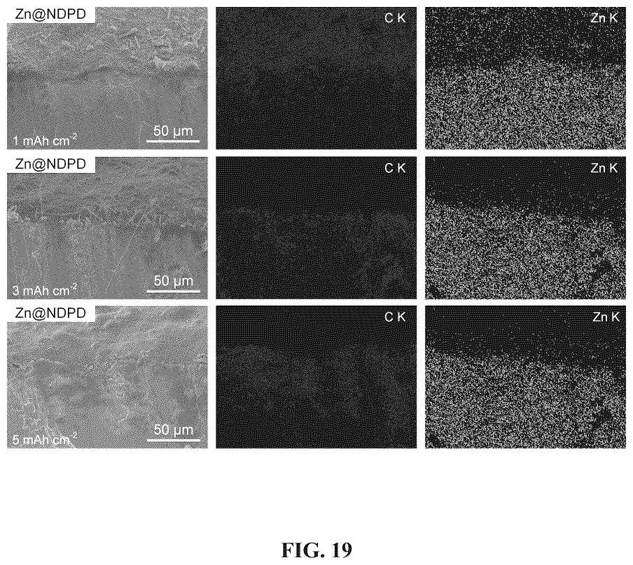

The NDPD also shows a higher ionic conductivity of 3.88×10⁻⁵ S cm⁻¹ than that of Zn@ND (1.13×10⁻⁵ S cm⁻¹) (FIG. 18B). Therefore, the NDPD layer serves as a zincophilic host that guides the plating Zn to deposit from the Zn metal surface to the coating NDPD particles' surface as demonstrated in FIG. 19.

### Example 6

### Cycling Performance of the Zn@NDPD Anodes

The galvanostatic charging/discharging (GCD) cycling performances of Zn anodes with different modifications are investigated for comparison. The nucleation barriers on Zn anode surfaces are evaluated with galvanostatic electroplating first.

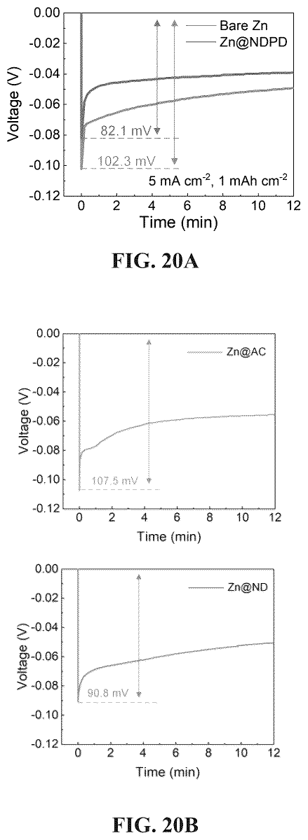

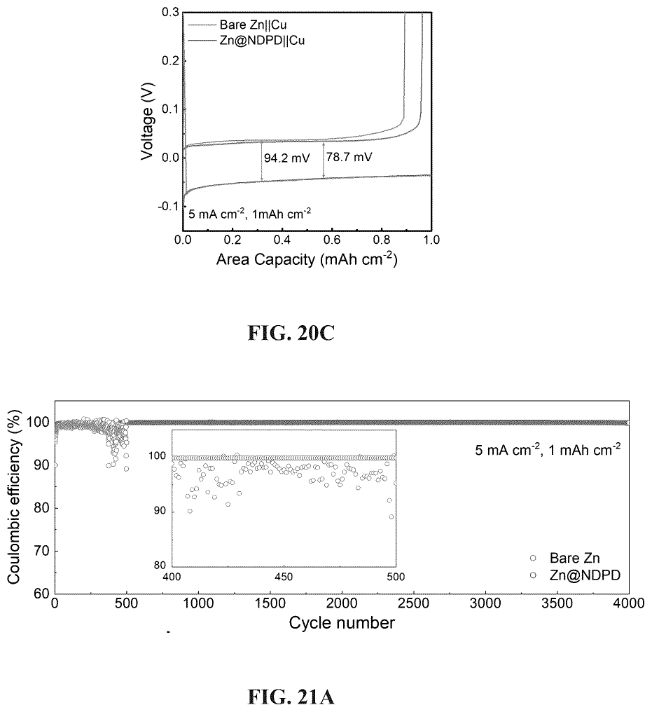

Referring to FIGS. 20A-20B, the overpotentials of Zn∥Zn and Zn@NDPD∥Zn@NDPD symmetric cells are tested. Zn@NDPD shows a small nucleation overpotential of 82.1 mV, which is significantly lower than its counterparts (102.3 mV for bare Zn, 107.5 mV for Zn@AC, 90.8 mV for Zn@ND), further verifying the enhanced zincophilicity with NDPD modification. This result is also supported by the reduced voltage hysteresis of Zn@NDPD∥Cu (78.4 mV) asymmetric cell than that of bare Zn∥Cu (94.2 mV) asymmetric cell (FIG. 20C).

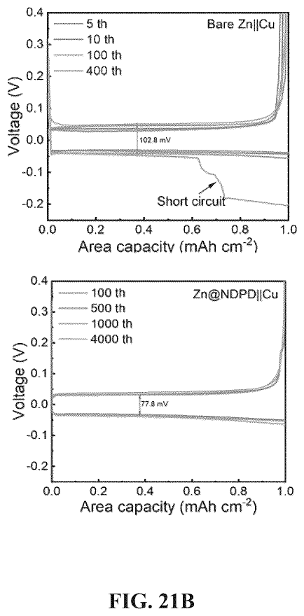

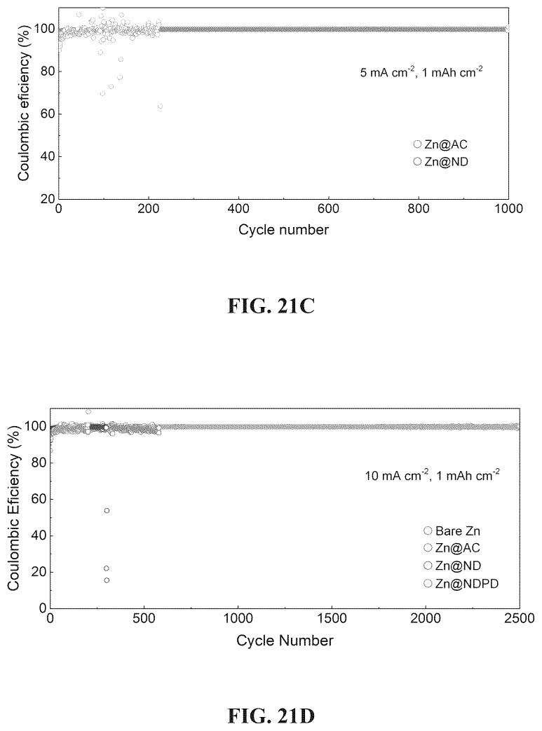

In addition, the CE is also measured in bare Zn∥Cu and Zn@NDPD∥Cu asymmetric cells to quantify the cyclic reversibility and stability of Zn anodes. In FIG. 21A, the Zn@NDPD anode presents an initial CE of 96.47% and an average CE of up to 99.9% with outstanding stability for over 4000 cycles at 5 mA cm⁻² for 1 mAh cm⁻². In striking contrast, the bare Zn anode manifests a much lower initial CE of 89.94% and an average CE of 99.0% with vigorous fluctuation and degradation after 400 cycles. The representative voltage curves of bare Zn∥Cu and Zn@NDPD∥Cu asymmetric cells are compared in FIG. 21B. The gap of the voltage plateau upon Zn plating/stripping for Zn@NDPD∥Cu asymmetric cells is well maintained at 77.8 mV even after 4000 cycles. In contrast, the bare Zn∥Cu cell delivers a much larger voltage gap that gradually increases during cycling, and the cell fails quickly after 400 cycles. Zn@AC∥Cu and Zn@ND∥Cu symmetric cells also suffer fast failure with lifetimes of 220 cycles and 1000 cycles, respectively (FIG. 21C). In addition, CE testing at 10 mA cm⁻² highlights the superior thermodynamic stability of Zn@NDPD with a cycling life of 2500 cycles, which is longer than bare Zn (300 cycles), Zn@AC (200 cycles) and Zn@ND (580 cycles), as shown in FIG. 21D.

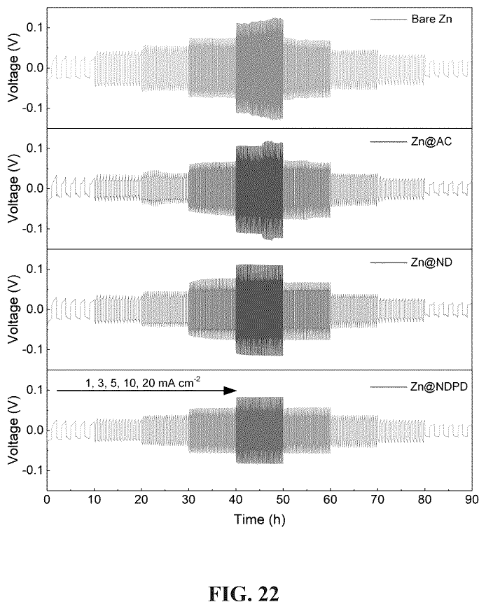

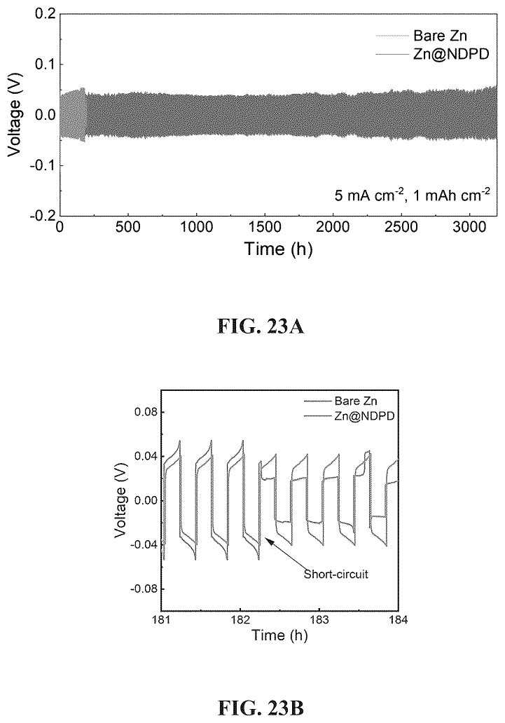

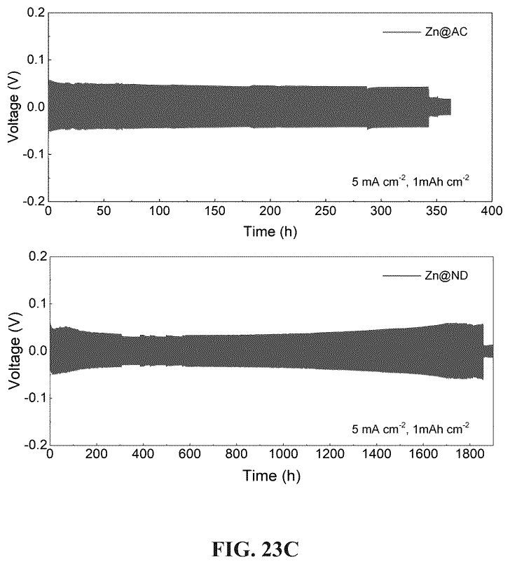

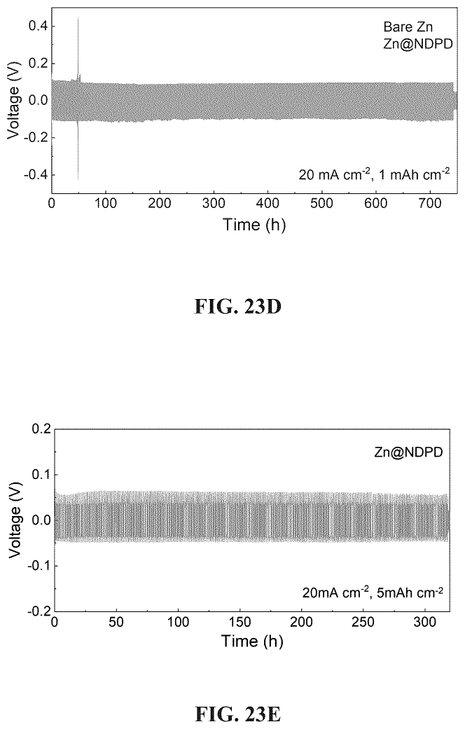

Moreover, the reversibility of electrodes is also evaluated for symmetric cells under different current densities and capacities. The rate performance of symmetric cells is examined with a fixed capacity of 1 mAh cm⁻², with the current densities varying from 1 to 20 mA cm⁻² (FIG. 22). Compared to its counterparts, Zn@NDPD has a voltage profile with less fluctuation and reduced hysteresis in each cycle, corresponding to the alleviated concentration polarization. Moreover, with the facilitated Zn deposition behavior and mechanical dendrite blocking of the NDPD coating in the long-term cycling, the Zn@NDPD symmetric cell manifests a significantly prolonged cycling life exceeding 3200 h with a steady voltage profile at 5 mA cm⁻² for 1 mAh cm⁻², surpassing the bare Zn (182 h), Zn@AC (342 h) and Zn@ND (1857 h) symmetric cells (FIGS. 23A-23C).

Building on this superior cycling performance, a cycling test is subsequently conducted for the Zn@NDPD symmetric cells at a significantly higher current density of 20 mA cm 2. FIG. 23D shows that the Zn@NDPD symmetric cell maintains excellent cycling performance for over 720 h, whereas the bare Zn symmetric cell is prone to deterioration after 48 h with a severe voltage fluctuation and an unexpected sharp decline in voltage. Impressively, even under a harsher operating condition of 20 mA cm⁻² with 5 mAh cm⁻², the Zn@NDPD symmetric cell still survives for more than 300 h, presenting outstanding reversibility and demonstrating the validity of Zn@NDPD anodes in practical application (FIG. 23E).

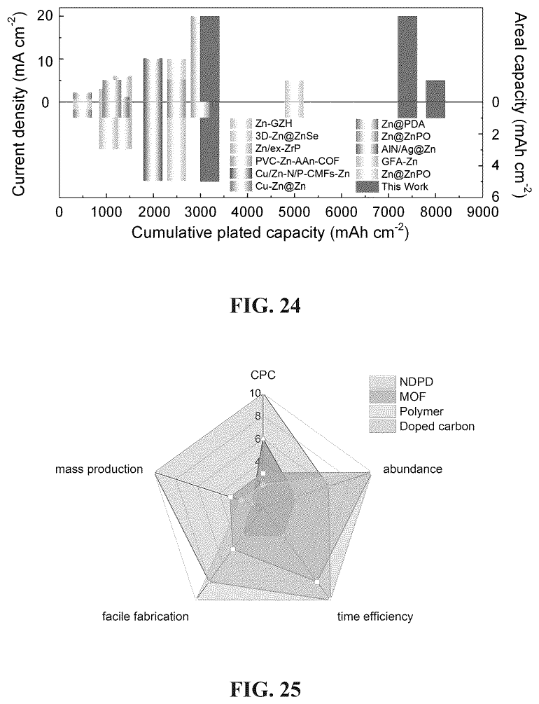

The cumulative plating capacities (CPC) of Zn anodes under different test conditions were also calculated and compared with those of variously reported AZIB anodes. As shown in FIG. 24 (with more details given in Table 2), the Zn@NDPD anode with an ultrahigh CPC of 8000 mAh cm⁻² outperforms most reported AZIB anodes that have been described thus far, showing the strong competitiveness of the chemical and mechanical synergistic protection strategy adopting amorphous-crystalline NDPD protection.

TABLE 2
Comparison of cyclic reversibility of
the Zn@NDPD and other commercial anodes

| | | Current | Capac- | | |
|---|---|---|---|---|---|
| | | densities | ities | CPCs | |
| | | (mA | (mAh | (mAh | |
| Anode | Electrolyte | cm⁻²) | cm⁻²) | cm⁻²) | Note |
| Zn@ZnPO | 2M ZnSO₄ | 5 | 1 | 2500 | Prior |
| 3D-Zn@ZnSe | 2M ZnSO₄ | 0.5 | 0.5 | 500 | art |
| Zn@PDA | 2M ZnSO₄ | 2 | 1 | 500 | |
| Zn@GPE | / | 1 | 1 | 2500 | |
| GFA-Zn | 1M ZnSO₄ | 3 | 3 | 1050 | |
| Zn/ex-ZrP | 2M ZnSO₄ | 6 | 3 | 1350 | |
| PVC-Zn-AAn-COF | 1M ZnSO₄ | 20 | 1 | 3000 | |
| Cu—Zn@Zn | 3.0M | 5 | 1 | 1125 | |
| | Zn(CF₃SO₃)₂ | | | | |
| Zn-GZH | 2M ZnSO₄ | 10 | 5 | 2500 | |
| AlN/Ag@Zn | 2M ZnSO₄ | 1 | 1 | 1300 | |
| Cu/Zn—N/P-CMFs- | 2M ZnSO₄ | 10 | 5 | 2000 | |
| Zn | | | | | |
| Zn@ZnPO | 2M ZnSO₄ | 5 | 1 | 5000 | |
| Zn@NDPD | 2M ZnSO₄ | 5 | 1 | 8000 | This |
| | | | | | work |
| Zn@NDPD | 2M ZnSO₄ | 20 | 1 | 7400 | This |
| | | | | | work |
| Zn@NDPD | 2M ZnSO₄ | 20 | 5 | 3200 | This |
| | | | | | work |

Besides, a comprehensive comparison between Zn@NDPD and reported Zn anodes is shown in FIG. 25 and Table 3, indicating the enormous potential for the application in the future.

TABLE 3
A comprehensive comparison between NDPD, mof, polymer and doped carbon

| | | | | MOF | | | Polymer | | | Doped carbon | | |
|---|---|---|---|---|---|---|---|---|---|---|---|---|
| | | NDPD | | details | | | details | | | details | | |
| | content | details | score^{a} | (e.g. Ref⁷) | | score^{a} | (e.g. Ref³) | | score^{a} | (e.g. Ref¹¹) | | score^{a} |
| facile | instrument | furnace | 8 | ultrasonic | | 3 | oven, | | 10 | centrifuge, | | 5 |
| fabrication | | | | machine, | | | centrifuge | | | ultrasonic | | |
| | | | | freeze pump, | | | | | | machine, | | |
| | | | | oven, | | | | | | electrospinning | | |
| | | | | centrifuge, | | | | | | machine, | | |
| | | | | vacuum oven | | | | | | furnance | | |
| | procedure | stirring, | 8 | sonication, | | 3 | stirring, | | 10 | stirring, | | 4 |
| | | drying, | | flash freezing, | | | filtration, | | | filtration, | | |
| | | heating, | | heating, | | | drying | | | electrospinning, | | |
| | | | | filtration | | | | | | calcination | | |
| | total access | simple | 8 | complex | | 3 | simple | | 10 | complex | | 4.5 |
| | | procedures | | procedures | | | procedures | | | procedures, | | |
| | | and | | and | | | and | | | simple | | |
| | | equipments | | equipments | | | equipments | | | equipments | | |
| performance | cycling | CPC | 10 | CPC | | 6 | CPC | | 2 | CPC | | 3 |
| | stability | | | | | | | | | | | |
| time | synthesis | ~32 h | 10 | ~102 | h | 3 | ~36 | h | 9 | ~48 | h | 6 |
| efficiency | time | | | | | | | | | | | |
| mass | mass of the | ~30 g | 10 | <100 | mg | 1 | <200 | mg | 2 | <300 | mg | 3 |

| | | | | | | | | | |
|---|---|---|---|---|---|---|---|---|---|
| production | product | | | | | | | | |
| abundance | source | the polymer | 6 | some of the | 3 | resources of | 10 | resources of | 10 |
| | | used are | | organic | | reagent are | | reagent are | |
| | | common and | | reagent used | | easy obtained | | easy obtained | |
| | | easy | | are complex | | | | | |
| | | produced; the | | to be | | | | | |
| | | nano diamond | | synthesized | | | | | |
| | | is complex to | | and their yield | | | | | |
| | | be synthesized | | is low | | | | | |

^{a}These scores are based on the practical performances or synthesis methods reported (in the range of 0-10)

### Example 7

### Density Functional Theory (DFT) Calculations and Theoretical Simulations

To uncover the improved electrochemical stability and enhanced deposition thermodynamics and kinetics, DFT calculations and theoretical simulations adopting the finite element method (FEM) are conducted.

Periodic density functional theory calculations were performed using Vienna ab initio simulation package (VASP). The projected augmented wave method and the generalized gradient function approximation in the Perdew-Burke-Ernzerhof (PBE) correlation function are used to describe the interaction between core and valence electrons. The van der Waals interaction is considered by Grimme's DFT-D3 correction. The energy cut-off is set at 500 eV for all calculations. The convergence criteria for the energy and force are set at 1×10⁻⁵ eV and 0.02 eV/Å, respectively. To prevent artifacts in the surface calculations caused by interactions of periodic replicas in the z direction, a minimum of 20 Å of vacuum layers is included in the supercell. The structures are fully relaxed with a gamma-center medium (0.03) k-mesh and used to calculate the adsorption of Zn ions. The adsorption energy of a Zn ion on these slab models is calculated as:

$$Δ {E}_{ad} = {E}_{tot} - {E}_{slab} - {E}_{bulk Zn}$$

where Eₜₒₜ is the total electronic energy of the slab+Zn system, E_{slab} is the energy of clean slabs, and E_{bulk Zn} is the energy of a Zn atom in the bulk phase.

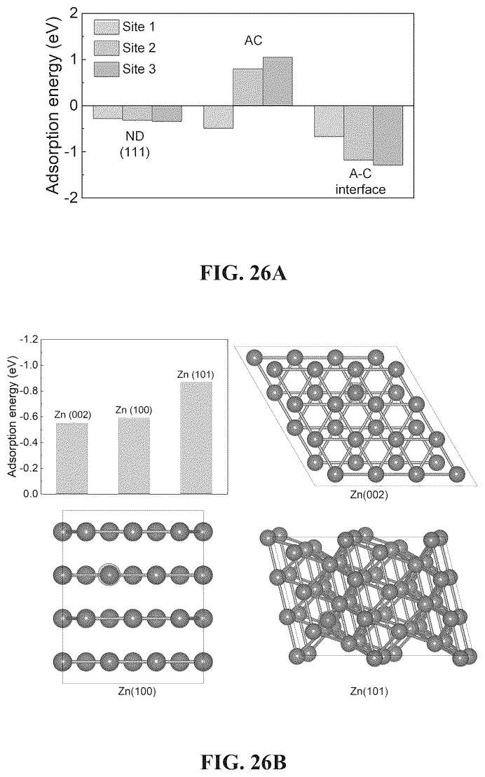

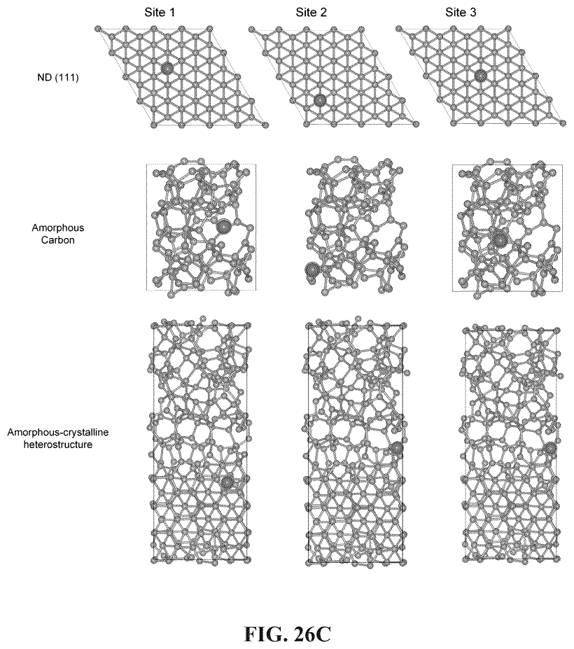

Besides the amorphous-crystalline heterointerface (A-C interface) of the NDPD, the interactions of bare Zn, ND, and AC with Zn atoms are also analyzed. The adsorption energies of Zn atoms at different sites are summarized (FIG. 26A-26C). The results show that the A-C interface sites have the lowest adsorption energy (−0.67 eV, −1.18 eV, −1.29 eV, respectively) among the models. While the adsorption energies for ND (−0.28 eV, −0.32 eV, −0.34 eV, respectively) and AC (−0.49 eV, 0.80 eV, 1.05 eV) are higher than those of Zn (002), Zn (100), and Zn (101) substrate (−0.55, −0.59, and −0.87 eV, respectively), highlighting the impact of the amorphous-crystalline dual-phase heterostructure in terms of improving the Zn affinity of Zn anodes.

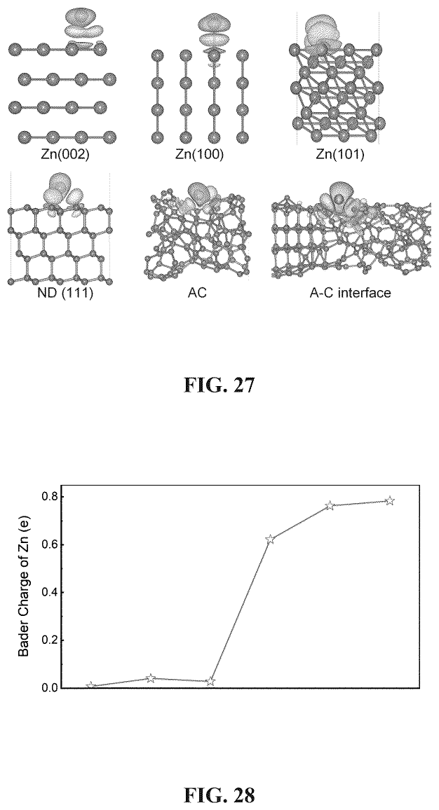

To further explain the principle of enhanced Zn affinity, the charge density difference is calculated to analyse the charge variation during Zn atom adsorption, as shown in FIG. 27. These results show that the active sites of NDPD, especially the heterointerfaces, present a significant depletion of electrons when adsorbing the Zn atoms, demonstrating the effective promotion of electron transfer from active sites to Zn²⁺. Bader charges of Zn atoms at different sites are calculated, as summarized in FIG. 28. The Zn atoms adsorbed on the Zn (002), (100), and (101) planes exhibit a very low Bader charge (0.007 e, 0.041 e, and 0.028 e, respectively), and a higher Bader charge in the NDPD components (0.783 e, 0.621 e, and 0.762 e for the A-C interface, ND and AC, respectively), further indicating that the interfacial electron transfer is significantly increased by the amorphous-crystalline dual-phase heterostructure coating. Both the adsorption energy and charge density difference results demonstrate the robust interaction between Zn atoms and A-C interfaces of the NDPD, resulting in enhanced Zn deposition thermodynamics and kinetics.

To clarify the fundamental physical mechanism of Zn²⁺ deposition on the whole electrode, the space electrostatic field without and with NDPD coating on the Zn anode is further analyzed by FEM results.

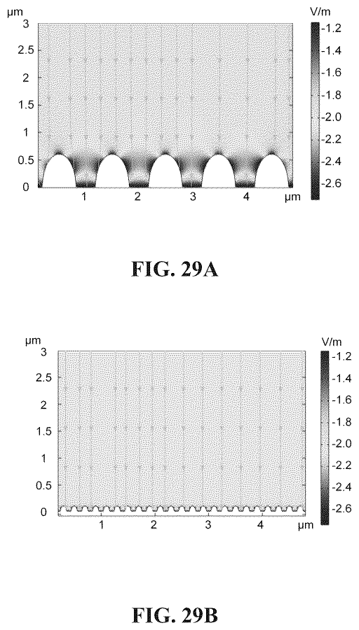

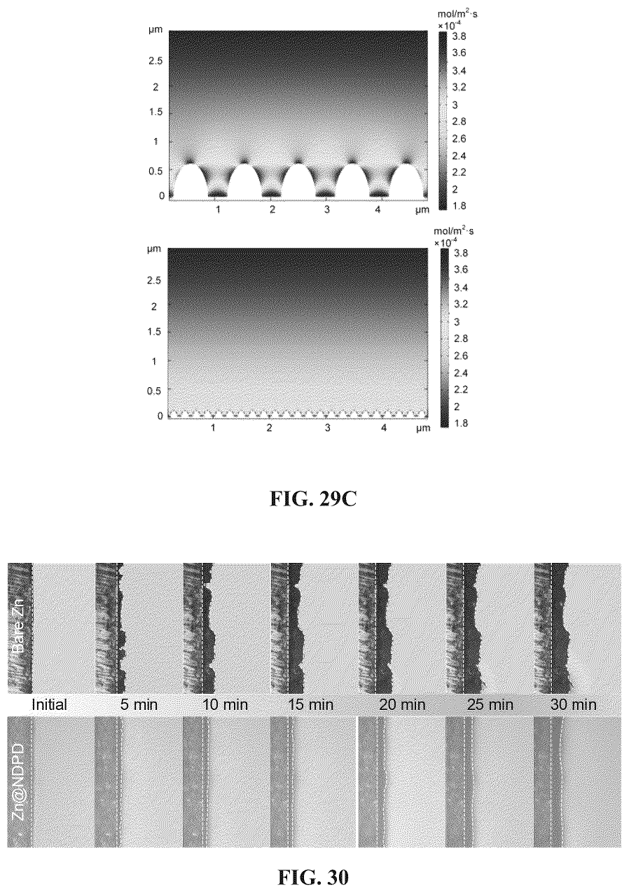

In the bare Zn anode model, the convergence of the spatial electrostatic field in a specific region results in the local deposition of Zn²⁺ and the further formation of Zn dendrites (FIG. 29A). Whereas the spatial electrostatic field is redistributed by the porous NDPD in Zn@NDPD (FIG. 29B), ensuring uniform Zn deposition. Further, the Zn²⁺ flux at the anode and electrolyte interface is obtained from the FEM results. Referring to FIG. 29C, the Zn²⁺ flux tends to concentrate at the protuberances of bare Zn anodes and causes the “hot-spot” deposition. In contrast, Zn²⁺ flux concentration polarization is relieved to realize a uniform deposition on the Zn@NDPD.

Furthermore, the deposition process for the bare Zn and Zn@NDPD at 10 mA cm⁻² is detected using an in-situ optical microscope to demonstrate the modified deposition behavior.

FIG. 30 shows that the Zn plating layer on the bare Zn surface is randomly distributed with many protrusions, whereas a flat deposition layer forms on the surface of Zn@NDPD, further indicating that regulated Zn²⁺ flux and deposition promotes homogeneous nucleation and uniform growth of Zn.

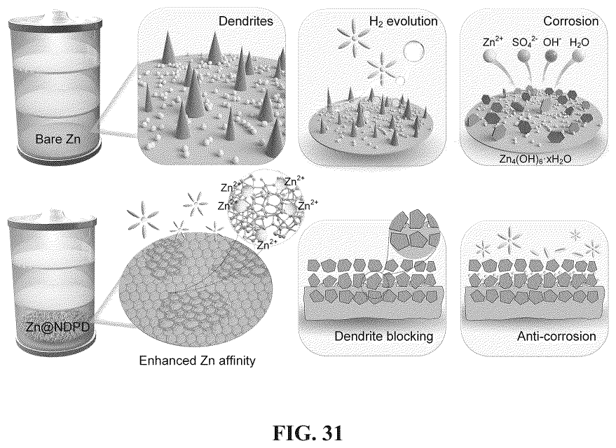

Given the theoretical calculations and experiment evaluation, the optimized deposition mechanism of Zn anodes with NDPD can be elucidated as shown in FIG. 31. The hydrophobicity of the NDPD enables a lower energy barrier for Zn²⁺ desolvation and a lower propensity for HER and the resulting corrosion and surface passivation. Subsequently, the nano-porous structure of NDPD regulates the electric field to homogenize the Zn²⁺ flux distribution, realizing uniform deposition. In addition, the NDPD serves as a mechanical barrier against dendrite propagation and growth owing to its exceptional hardness. Furthermore, compared with bare Zn and ND, NDPD with distinctive amorphous-crystalline heterointerfaces shows impressively improved Zn affinity and interfacial interactions, inducing fast and even Zn nucleation and deposition. This synergistic protection with mechanical and chemical properties of NDPD, enabling the prohibition of dendrite propagation and parasitic reactions, presents a stable Zn@NDPD anode with a prolonged cycling lifespan.

### Example 8

### Assembly of an Aqueous Zn@NDPD∥Cu-MnO₂ Full Cell

### Preparation of Cu—MnO₂ Cathode

Cu²⁺ pre-intercalation 8-MnO₂ (Cu—MnO₂) powder for the cathode is synthesized by adopting a simple hydrothermal reaction. Briefly, CuCl₂·2H₂O, MnSO₄, and KMnO₄ are fully dissolved in deionized water at a molar ratio of 1:1:6. The solution is then used in hydrothermal experiments at 160° C. for 12 h. The black precipitates obtained are centrifuged and washed with deionized water several times and dried in vacuum at 60° C. for 12 h.

The synthesized Cu—MnO₂ powder is coated on the stainless-steel mesh with a typical mass loading of 1-1.5 mg cm⁻².

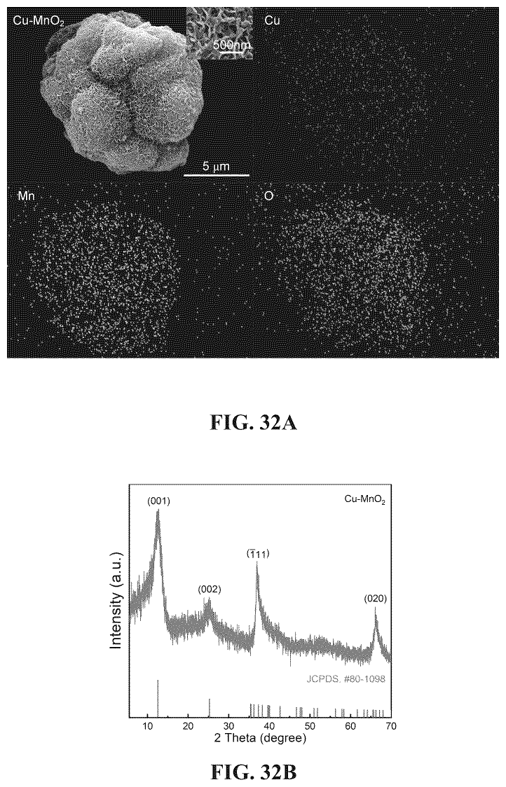

The Cu—MnO₂ cathode is assembled with either bare Zn or Zn@NDPD anodes to create the full cell configuration. The assembly process includes integrating the Cu—MnO₂ cathode with the respective anodes, using a suitable separator to prevent direct contact between the anode and cathode, and an electrolyte to facilitate ion transport between the electrodes. This complete cell assembly is then used to evaluate the electrochemical performance and stability of the different anode configurations. The relative morphology, composite, and phase characterization of Cu—MnO₂ are presented in FIGS. 32A-32B.

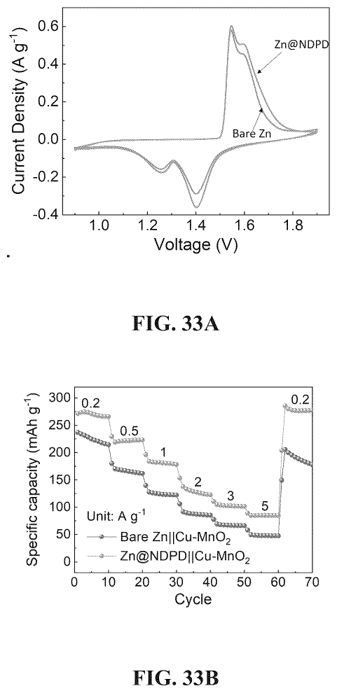

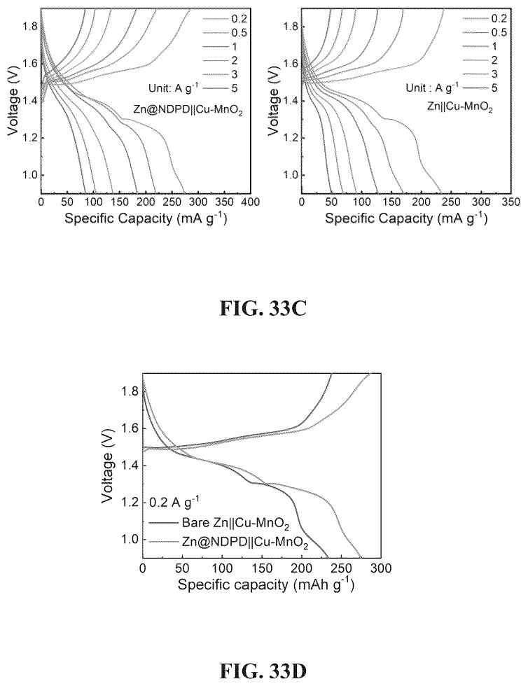

The CV profiles are collected for assembled full cells of Zn∥Cu-MnO₂ and Zn@NDPD∥Cu-MnO₂ at 0.1 mV s⁻¹. Two pairs of redox peaks in CV curves imply the energy storage mechanism of the sequential H⁺ and Zn²⁺ insertion/extraction process (FIG. 33A). Additionally, the full cell with Zn@NDPD anode manifests a more positive cathodic peak potential and more negative anodic peak potential, suggesting that the Zn@NDPD∥Cu-MnO₂ full cell has a smaller voltage polarization than the bare Zn counterpart owing to the enhanced zincophilicity. Besides, the higher current density of Zn@NDPD∥Cu-MnO₂ suggests enhanced electrochemical activity. As expected, through the better protection and optimized deposition provided by NDPD, the Zn@NDPD∥Cu-MnO₂ full cell presents a superior rate performance at different current densities than its counterpart (FIGS. 33B-33C). The enhanced deposition kinetics resulting from amorphous-crystalline heterostructure contribute to lower voltage polarization and increased specific capacity under different current densities.

In particular, the Zn@NDPD∥Cu-MnO₂ full cell presents a high average reversible capacity of 85.3 mAh g⁻¹ at 5 A g⁻¹, which is almost twice that of the counterpart (49.0 mAh cm⁻²). When the current density returns to 0.2 A g⁻¹, the GCD profile of the Zn@NDPD∥Cu-MnO₂ full cell still presents a smaller redox voltage gap than that of the profile of the full cell with a bare Zn anode, indicating well-maintained voltage polarization optimization (FIG. 33D).

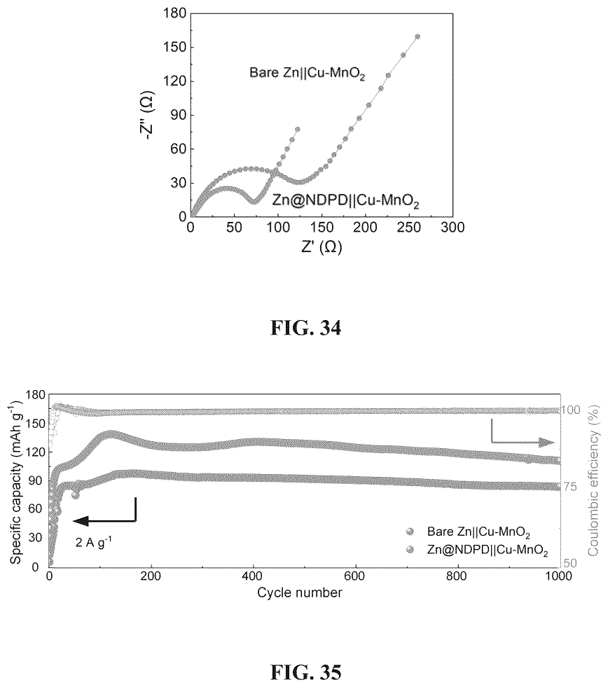

Low charge transfer resistance (R_{ct}) is usually a good sign of a superior cell. Charge-transfer data are thus obtained from the EIS analysis. As shown in FIG. 34, the Zn@NDPD∥Cu-MnO₂ has a much smaller R_{ct} of 70Ω than the control sample, suggesting a rapid electron transfer for Zn@NDPD, which can be mainly attributed to the enhanced Zn deposition kinetics of the NDPD. Benefiting from the improved electron transfer, the Zn@NDPD∥Cu-MnO₂ retains a high reversible specific capacity of 110.5 mAh g⁻¹ even after 1000 cycles at 2 A g⁻¹, whereas the bare Zn∥Cu-MnO₂ exhibits a lower specific capacity of 83.8 mAh g⁻¹ (FIG. 35).

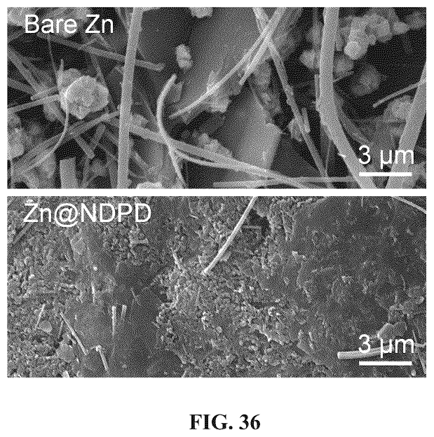

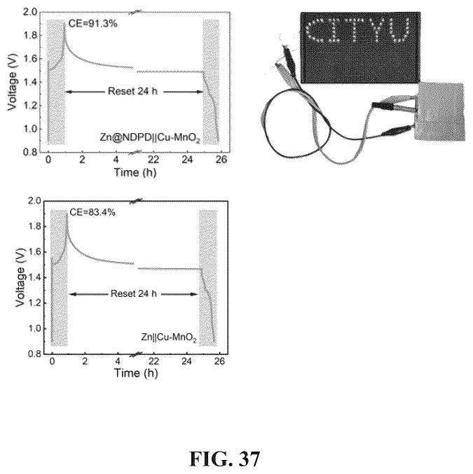

The morphology of Zn anodes after 1000 cycles is investigated to clarify the mechanism of the capacity decay. As displayed in FIG. 36, the Zn@NDPD anode shows superior anti-corrosion performance and maintains a flat surface, whereas the bare Zn anode is covered by massive ZHS flakes, indicating that the notorious surface passivation causes the lower capacity during the cycling process. In addition, the self-discharge behavior of the Zn@NDPD∥Cu-MnO₂ is also mitigated by the depressed side reactions. As observed in FIG. 37, after a rest of 24 h, the Zn@NDPD∥Cu-MnO₂ holds 91.3% of its original capacity, much higher than the percentage for the bare Zn∥Cu-MnO₂ (83.4%). Furthermore, Zn@NDPD∥Cu-MnO₂ punch cells are assembled as a power source for light-emitting diode (LED) patterns, demonstrating the applicability of the Zn@NDPD∥Cu-MnO₂ in everyday electronic devices.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments are chosen and described in order to best explain the principles of the invention and its practical application, thereby enabling others skilled in the art to understand the invention for various embodiments and with various modifications that are suited to the particular use contemplated.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

Throughout this specification, the term “nano dual-phase diamond (NDPD)” refers to a nanomaterial characterized by an amorphous-crystalline heterostructure. This material is fabricated through a specific process involving the integration of both amorphous and crystalline diamond phases at the nanoscale. The unique properties of NDPD include exceptional hardness and zincophilic behavior, which contribute to its enhanced performance in various applications, such as in electrode materials.

The term “amorphous-crystalline heterostructure” refers to a material structure wherein both amorphous (non-crystalline) and crystalline phases coexist within the same material. In the context of NDPD, this heterostructure plays a crucial role in optimizing electrochemical performance by combining the beneficial properties of both phases, such as hardness and structural stability.

The term “zincophilic properties” refers to the material's affinity for zinc ions, which promotes efficient and uniform deposition of zinc during electrochemical processes. This property helps in minimizing issues related to zinc deposition and contributes to a reduced nucleation overpotential.

The term “nucleation overpotential” denotes the additional voltage required to initiate the nucleation process during electrodeposition. A lower nucleation overpotential indicates improved efficiency in the electrodeposition process.

The term “hydrophobicity” refers to the property of a material that repels water, preventing water-mediated side reactions and thereby enhancing the long-term stability of the anode. In the context of NDPD, hydrophobicity contributes to improved performance and durability of the electrode material.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### REFERENCES: THE DISCLOSURES OF THE FOLLOWING REFERENCES ARE INCORPORATED BY REFERENCE

1. Liu, Y.; Tzeng, Y.-K.; Lin, D.; Pei, A.; Lu, H.; Melosh, N. A.; Shen, Z-X.; Chu, S.; Cui, Y. An Ultrastrong Double-Layer Nanodiamond Interface for Stable Lithium Metal Anodes. Joule 2018, 2, 1595-1609.
2. Jiao, W.; Zohair, M.; Eaves-Rathert, J.; Ramamurthy, J.; Harkaway, A.; Mort, R.; Wheaton, J.; Jiang, S.; Martin, S. W.; Pint, C. L. Critical Role of Pressure for Chemo-Mechanical-Induced Stability of Sodium Metal Battery Anodes. ACS Energy Lett 2023, 8 (6), 2711-2717.
3. Kamali, A. R. Black Diamond Powder: On the Thermal Oxidation and Surface Graphitization. Appl. Surf. Sci 2021, 551, 149371.
4. Yu, X.; Li, Z.; Wu, X.; Zhang, H.; Zhao, Q.; Liang, H.; Wang, H.; Chao, D.; Wang, F.; Qiao, Y.; Zhou, H.; Sun S-G. Ten Concerns of Zn Metal Anode for Rechargeable Aqueous Zinc Batteries. Joule 2023, 7, 1145-1175.
5. Yang, Y.; Liu, C.; Lv, Z.; Yang, H.; Zhang, Y.; Ye, M.; Chen, L.; Zhao, J.; Li, C. C. Synergistic Manipulation of Zn²⁺ Ion Flux and Desolvation Effect Enabled by Anodic Growth of a 3D ZnF₂ Matrix for Long-Lifespan and Dendrite-Free Zn Metal Anodes. Adv. Mater 2021, 33, 2007388.

What is claimed is:

1. An aqueous zinc-based battery with a high hardness heterostructure material, comprising:
a reversible and dendrite-free anode comprising an anode material and a barrier layer with a hardness of at least 60 GPa coated on the anode material, wherein the barrier layer is made from a local graphitization material having a nanoscale three-dimensional amorphous-crystalline heterostructure;
a cathode comprising a cathode material;
a separator between the reversible and dendrite-free anode and the cathode; and
an electrolyte comprising an aqueous solution that is in ionic contact with both the reversible and dendrite-free anode and the cathode through the separator,
wherein an amorphous carbon domain is embedded in a crystalline matrix of the local graphitization material, and
wherein the barrier layer reduces a desolvation energy barrier for Zn²⁺ ions.

2. The aqueous zinc-based battery of claim 1, wherein the barrier layer exhibits hydrophobicity to prevent water-mediated side reactions at the reversible and dendrite-free anode surface.

3. The aqueous zinc-based battery of claim 1, wherein the local graphitization material comprises diamond-derived materials, activated carbon, carbide, boride, nitride, or a combination thereof.

4. The aqueous zinc-based battery of claim 3, wherein the local graphitization material is nano dual-phase diamond particles fabricated via a thermal treatment.

5. The aqueous zinc-based battery of claim 1, wherein the anode material comprises zinc foil, zinc powder, zinc plate, or zinc alloy.

6. The aqueous zinc-based battery of claim 1, wherein the cathode material comprises MnO₂, ZnMn₂O₄, V₂O₅, NH₄V₄O₁₀, or a combination thereof.

7. The aqueous zinc-based battery of claim 1, wherein the separator comprises glass fiber, polymer membranes comprising polyacrylonitrile, Nafion, polyvinyl alcohol, or cellulose-based materials comprising lignocellulose, g-C3N4 modified cellulose, cotton cellulose.

8. The aqueous zinc-based battery of claim 1, wherein the electrolyte comprises ZnSO₄, Zn(CF₃SO₃)₂, Zn(CH₃COO)₂, ZnCl₂, KOH solutions, or a combination thereof.

9. The aqueous zinc-based battery of claim 1, wherein the nanoscale three-dimensional amorphous-crystalline heterostructure is characterized by a broad peak of amorphous structure centered at approximately 2θ equal to 26°.

10. The aqueous zinc-based battery of claim 1, wherein the reversible and dendrite-free anode is configured to exhibit reduced hydrogen evolution reaction and enhanced anti-corrosion performance compared to a bare zinc anode.

11. The aqueous zinc-based battery of claim 1, wherein the local graphitization material has an irregular flake morphology with an average size of approximately 200 nm.

12. The aqueous zinc-based battery of claim 1, wherein the aqueous zinc-based battery exhibits a cycling stability of at least 3000 hours at a current density of 5 mA/cm² with a capacity of 1 mAh/cm².

13. The aqueous zinc-based battery of claim 1, wherein the aqueous zinc-based battery maintains a nucleation overpotential of less than 90 mV during cycling.

14. The aqueous zinc-based battery of claim 1, wherein the aqueous zinc-based battery exhibits a cumulative plating capacity of at least 8000 mAh/cm² during long-term cycling.

15. A method of fabricating a barrier layer with a hardness of at least 60 GPa for use in a reversible and dendrite-free anode, comprising:
mixing one or more synthetic nano diamond particles with an acrylic acid ammonium salt polymer, a monomer, a cross-linking agent, a photoinitiator, and water to form a slurry;
drying the slurry at a temperature of approximately 80° C. for 1-4 hours;
sintering the dried slurry in an argon atmosphere at a temperature ranging from 900° C. to 2000° C. at a ramp rate of 5° C. per minute to obtain a local graphitization material, wherein the local graphitization material is formed with a nanoscale three-dimensional amorphous-crystalline heterostructure; and
spin-coating the local graphitization material onto an anode material to form the barrier layer.

16. The method of claim 15, wherein the sintering process is conducted for a duration of approximately 30 hours.

17. The method of claim 15, further comprising a cooling step following the sintering process to gradually reduce the temperature of the local graphitization material.

18. The method of claim 15, wherein the photoinitiator comprises 2-hydroxy-2-methylpropiophenone and diphenyl(2,4,6-trimethylbenzoyl)phosphine oxide, the monomer comprises acrylamide or acrylic acid, and the cross-linking agent comprises N,N′-methylenebisacrylamide or hexamethylene diisocyanate.

19. The method of claim 15, wherein the slurry comprises
50-70 wt % of one or more synthetic nano diamond particles;
1-5 wt % of acrylic acid ammonium salt polymer;
1-5 wt % of monomer;
1-5 wt % of cross-linking agent;
0.1-5 wt % of photoinitiator;
1-10 wt % of water.
